(19) United States
(12) Patent Application Publication
(10) Pub. No.: US 2024/0211947 A1
(43) Pub. Date: Jun. 27, 2024

(54) METHODS AND SYSTEMS FOR IDENTITY VERIFICATION IN CRYPTOGRAPHIC TRANSACTIONS

(71) Applicant: DISH Wireless L.L.C., Englewood, CO (US)

(72) Inventors: Christopher William Krasny Ergen, Littleton, CO (US); Charles W. Ergen, Littleton, CO (US); Charles Edwards, Lausanne (CH)

(21) Appl. No.: 18/391,427

(22) Filed: Dec. 20, 2023

Related U.S. Application Data
(60) Provisional application No. 63/434,698, filed on Dec. 22, 2022.

(51) Int. Cl. G06Q 20/40; G06Q 20/36; H04L 9/00

(52) U.S. Cl. CPC G06Q 20/4014; G06Q 20/36; H04L 9/50

(57) ABSTRACT

A computer system receives a verification request from a computer device associated with a digital wallet. The verification request includes identification information identifying an entity associated with the wallet. In response to receiving the verification request, the computer system generates an identity verification token using the KYC standard and based on the identification information. The an identity verification token verifies the entity associated with the wallet. The computer system transmits the identity verification token to the computer device for performing a cryptographic transaction linked to the wallet. The computer system receives a validation request associated with the cryptographic transaction from a transaction server. The validation request includes the identity verification token. In response to receiving the validation request, the computer system validates the identity verification token to generate validation information. The computer system transmits the validation information to the transaction server for performing the cryptographic transaction.

### CROSS-REFERENCE TO RELATED APPLICATION

This application claims priority to and the benefit of U.S. Provisional Application No. 63/434,698 (attorney docket no. 120299.8140.US00), filed Dec. 22, 2022 and titled “VIRTUAL CURRENCY WITH INCORPORATED IDENTITY CREDENTIALS,” the contents of which is incorporated herein by reference in its entirety.

### BACKGROUND

The use of virtual currencies and especially cryptocurrencies such as Bitcoin, Ethereum, and Litecoin has increased in popularity in recent years. Bitcoin and other cryptocurrencies are not tied to a government, are decentralized, and enable direct transactions between entities while maintaining the trust and stability of fiat currencies. However, despite the popularity of cryptocurrencies, they are not widely accepted. At present, virtual currencies are not widely accepted at several retail merchants, or even by most online merchants. This lack of mass adoption of cryptocurrencies can be attributed to the long transaction times sometimes needed for transaction verification. Transaction processing time for cryptographic currencies can sometimes be impractically large. For example, it is not practical to perform a transaction that could take hours for confirmation by recording the transaction to a blockchain. Moreover, cryptocurrencies are typically associated with anonymous identities. Hence, virtual currency is sometimes susceptible to money laundering activities and can expose merchants to an increased likelihood of transacting with criminals, that could place merchants in violation of state and federal laws. In addition, virtual currencies can pose challenges such as exchange rate fluctuation with fiat currencies, leading to unacceptable risk.

### BRIEF DESCRIPTION OF THE DRAWINGS

Detailed descriptions of implementations of the present technology will be described and explained through the use of the accompanying drawings.

FIG. 1 is a block diagram that illustrates an example system that can implement aspects of the present technology.

FIG. 2 is a block diagram that illustrates an example transaction block that can implement aspects of the present technology.

FIG. 3 is a flow diagram that illustrates an example process according to aspects of the present technology.

FIG. 4 is a block diagram that illustrates an example of a computer system in which at least some operations described herein can be implemented.

FIG. 5 is a flow diagram that illustrates an example process according to aspects of the present technology.

FIG. 6 is a block diagram illustrating components of at least a portion of an exemplary blockchain system, in accordance with one or more embodiments of this disclosure.

FIG. 7A is a drawing illustrating an application of a hash function, in accordance with one or more embodiments of this disclosure.

FIG. 7B is a block diagram illustrating an example cryptographic wallet, in accordance with one or more embodiments of this disclosure.

The technologies described herein will become more apparent to those skilled in the art from studying the Detailed Description in conjunction with the drawings. Embodiments or implementations describing aspects of the disclosure are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

Identity verification standards, such as Know Your Client (KYC) verification, are typically not used for performing virtual currency transactions, nor are systems in place to facilitate KYC verification for virtual transactions. Customer verification standards, such as KYC verification, require investment and services companies to verify the identity of their customers and any risks associated with the customer relationships based on particular standards. For example, KYC requires customers to provide a personal identification profile, and provides awareness to managers of potential risks and the positions of potential clients. However, conventional virtual currency transaction platforms pose challenges to performing identity verification because of the decentralized medium of exchanges occurring on such platforms that are designed to promote confidentiality. Conventional cryptocurrency transaction systems typically cannot verify entities fully because of the confidential nature of the distributed ledgers used by such systems. There is therefore a need for new and improved methods and systems for performing secure cryptographic transactions by entities verified using customer verification standards such as KYC.

This document discloses methods, systems, and apparatuses for identity verification in digital transactions. The identity verification can be associated with an identity verification standard (e.g., a KYC evaluation standard). KYC is beneficial for determining customer risk and whether the customer can meet standards to participate in virtual currency transactions. Compliance with KYC may be a requirement to participate in virtual currency transactions as a matter of law such as, for example, to comply with Anti-Money Laundering (AML) laws. For example, managers of transactions may be required under law to ensure transacting entities are not engaging in criminal activities while using their services. In some embodiments, an identity verifier (e.g., an authorization token linked to a virtual wallet) is obtained from an identity verification system and incorporated into a transaction request to a transaction manager associated with a distributed database (e.g., a distributed public ledger). The transaction manager can request an identity verifier from the receiving entity of the transaction. One or both of these identity verifiers can be sent to the identity verification system.

In some implementations, a computer system is used for performing a cryptographic transaction using an identity verification standard (e.g., a KYC evaluation standard). The computer system includes at least one hardware processor and at least one non-transitory memory storing instructions. The instructions, when executed by the at least one hardware processor, cause the computer system to receive a verification request from a computer device associated with a cryptographic wallet. The verification request includes identification information identifying an entity associated with the cryptographic wallet. In response to receiving the verification request, the computer system generates an identity verification token using the KYC standard based on the identification information. The identity verification token verifies the entity associated with the cryptographic wallet. The computer system transmits the identity verification token to the computer device for performing the cryptographic transaction. The cryptographic transaction is linked to the cryptographic wallet. The computer system receives a validation request associated with the cryptographic transaction from a transaction server. The validation request includes the identity verification token. In response to receiving the validation request, the computer system validates the identity verification token using the KYC standard to generate validation information for the entity associated with the cryptographic wallet. The computer system transmits the validation information to the transaction server for performing the cryptographic transaction linked to the cryptographic wallet.

In some implementations, a non-transitory computer-readable storage medium stores instructions that can be executed by at least one data processor of a first computer system. The instructions cause the first computer system to transmit a verification request to a second computer system. The verification request includes first identification information identifying a first entity associated with a first digital wallet, and second identification information identifying a second entity associated with a second digital wallet. The verification request is associated with a digital transaction between the first entity and the second entity. The first computer system receives an identity verification token verifying the first entity and the second entity from the second computer system. The identity verification token is generated using an identity verification standard and is based on the first identification information and the second identification information. In response to receiving the identity verification token, the first computer system links the digital transaction to the first digital wallet and the second digital wallet using the identity verification token. The first computer system performs the digital transaction by transferring an amount of virtual currency between the first digital wallet and the second digital wallet.

In some implementations, a computer system receives a verification request from a computer device associated with a digital wallet. The verification request includes identification information identifying an entity associated with the digital wallet. The computer system generates an identity verification token verifying the entity using an identity verification standard and based on the identification information. The computer system transmits the identity verification token to the computer device. The computer system receives a transaction request for performing a digital transaction from the computer device. The digital transaction is linked to the digital wallet. The transaction request includes the identity verification token. The computer system validates the identity verification token using the identity verification standard. The computer system performs the digital transaction linked to the digital wallet.

The benefits and advantages of the implementations described herein include providing a history of virtual currency flow through various virtual wallets by associating transaction and wallets to a verifiable identity that meets certain identification standards. The methods described herein overcome deficiencies of conventional currency and transaction processing mechanisms by automatically validating virtual transactions using entity verification of a sender of funds and/or a receiver of funds. The disclosed systems perform virtual currency transactions (e.g., of cryptocurrency) where the transmitting and/or receiving entity are verified according to an identity verification standard while maintaining confidentiality. The amount of necessary identifying information that is exposed to the transaction manager and the distributed network of devices managing the ledger is reduced.

The identity validation systems disclosed herein enable an entity (e.g., a local sovereign or a manager of a private network) to manage and track the use of funds to monitor that that the entities and corresponding transaction agents are participating in a transaction that meets a set of standards (e.g., laws of a sovereign, such as tax laws). Further, the apparatuses disclosed herein can be associated with KYC standards that include a due diligence process to verify customer identity, and assess and monitor customer risk. The disclosed methods can increase assurance that a customer is who they say they are. Compliance with KYC regulations, using the disclosed systems, mitigates money laundering, terrorism financing, and run-of-the-mill fraud schemes. By verifying a customer's identity and intentions and monitoring transaction patterns, institutions sovereign authorities can more accurately pinpoint suspicious activities.

The description and associated drawings are illustrative examples and are not to be construed as limiting. This disclosure provides certain details for a thorough understanding and enabling description of these examples. One skilled in the relevant technology will understand, however, that the disclosure can be practiced without many of these details. Likewise, one skilled in the relevant technology will understand that the disclosure can include well-known structures or features that are not shown or described in detail, to avoid unnecessarily obscuring the descriptions of examples.

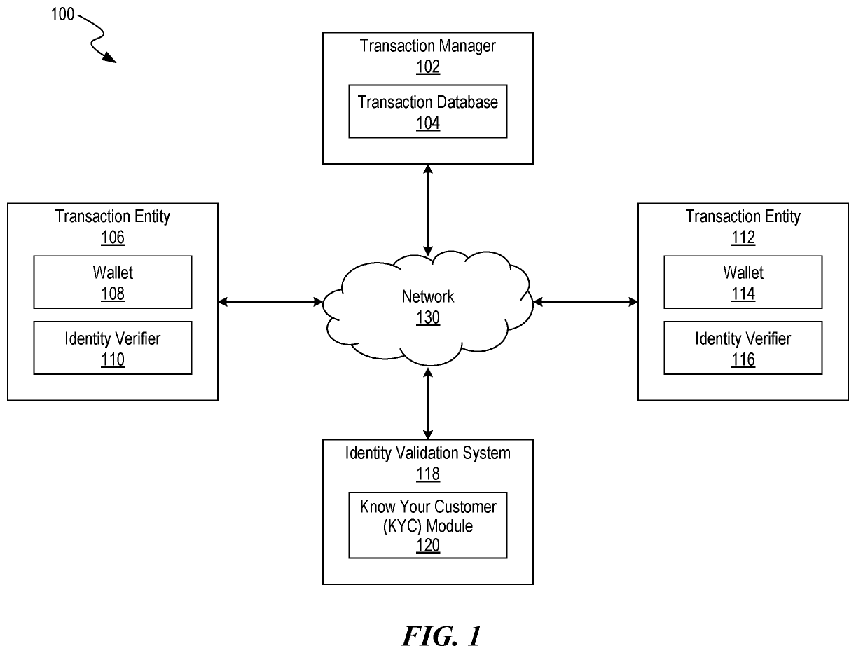

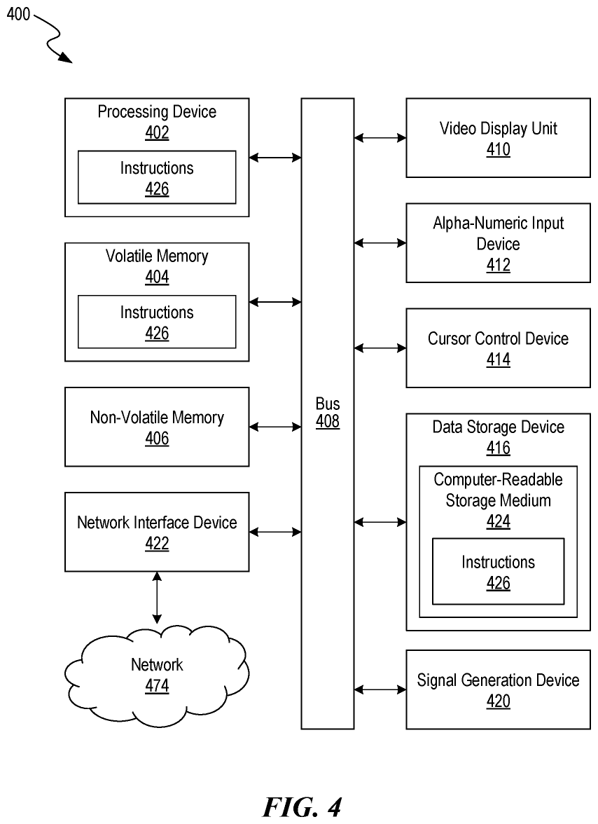

FIG. 1 is a block diagram that illustrates an example system 100 that can implement aspects of the present technology. System 100 includes a first transacting entity 106, a second transacting entity 112, a transaction manager 102 (sometimes referred to as a transaction server), and an identity validation system 118 (sometimes referred to as a “identity verification system”). In some embodiments, the transacting entities 106, 112, the transaction manager 102, and/or the identity validation system 118 is fully or partially integrated into one or more of the other enumerated elements of system 100. Transacting entities 106, 112, transaction manager 102, and/or identity validation system 118 can each be hosted by one or more computing devices including server computers, desktop computers, laptop computers, tablet computers, notebook computers, personal digital assistance (PDAs), set-top-boxes (STBs), mobile communication devices, cell-phones, hand-held computers, or similar computing devices. Transacting entities 106, 112, transaction manager 102, and identity validation system 118 are implemented using components of example computer system 400 illustrated and described in more detail with reference to FIG. 4. Likewise, embodiments of example system 100 can include different and/or additional components or can be connected in different ways.

The transacting entities 106, 112, transaction manager 102, and/or identity validation system 118 can be coupled to each other via a network 130 (e.g., for performing the methods described herein). In some embodiments, network 130 is a private network that provides each element of system 100 with access to each other element, and to other privately available computing devices. Network 130 can include one or more wide area network (WANs), local area networks (LANs), wired network (e.g., Ethernet network), wireless networks (e.g., an 802.11 network or a Wi-Fi network), cellular network (e.g., a Long Term Evolution (LTE) network or a fifth generation (5G) network), routers, hubs, switches, server computers, and/or any combination thereof. Alternatively or additionally, any of the elements of the system 100 can be integrated together or otherwise coupled without the use of network 130.

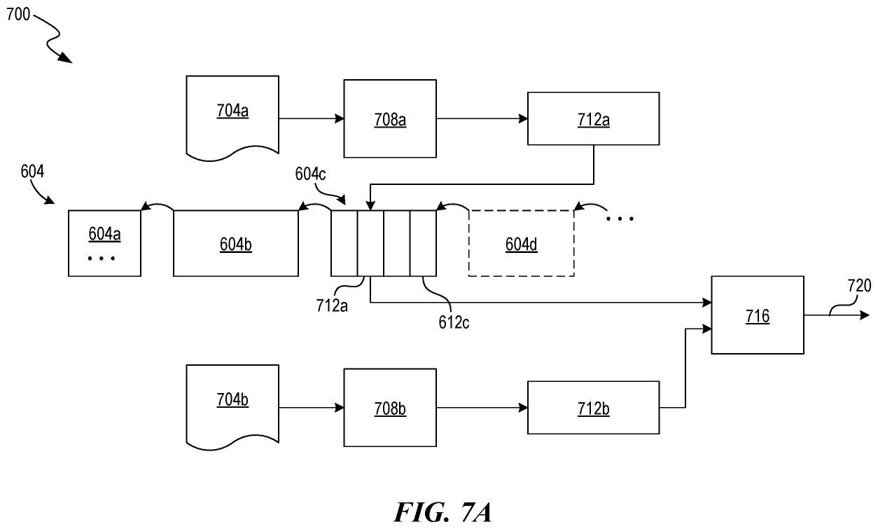

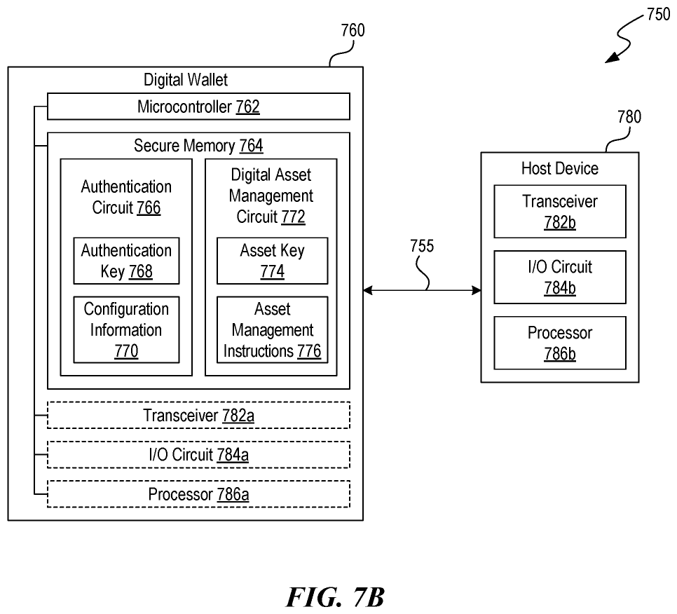

Transacting entities 106, 112 can each be individuals, companies, organizations, universities, or nonprofits, etc. Each of the transacting entities 106, 112 is represented in FIG. 1 by a client device or network having a processing device for performing the methods disclosed herein. For example, transacting entities 106, 112 can each use a computer device to transmit requests to the transaction manager 102 and/or the identity validation system 118. Transacting entities 106, 112 are associated with digital wallets 108, 114, respectively that are configured to store digital currency or virtual currency and identity verifiers 110, 116, respectively. Digital wallets are sometimes to simply as “wallets” herein. In some embodiments, either or both of the digital wallets 108, 114 are cryptographic wallets that can store cryptocurrency. The digital wallets 108, 114 are implemented using components of the example digital wallet 760 is illustrated and described in more detail with reference to FIG. 7B.

The digital wallets 108, 114 can each be a software wallet and/or a hardware wallet. In some implementations, a digital wallet includes a desktop program, a browser extension, and/or a mobile application. For example, a software wallet can include a software program (e.g., a desktop program, a browser extension, and/or a mobile application) that enables access to functions performed on virtual currency, such as transmitting, receiving, exchanging, and/or storing a virtual currency (e.g., a cryptocurrency), among other things.

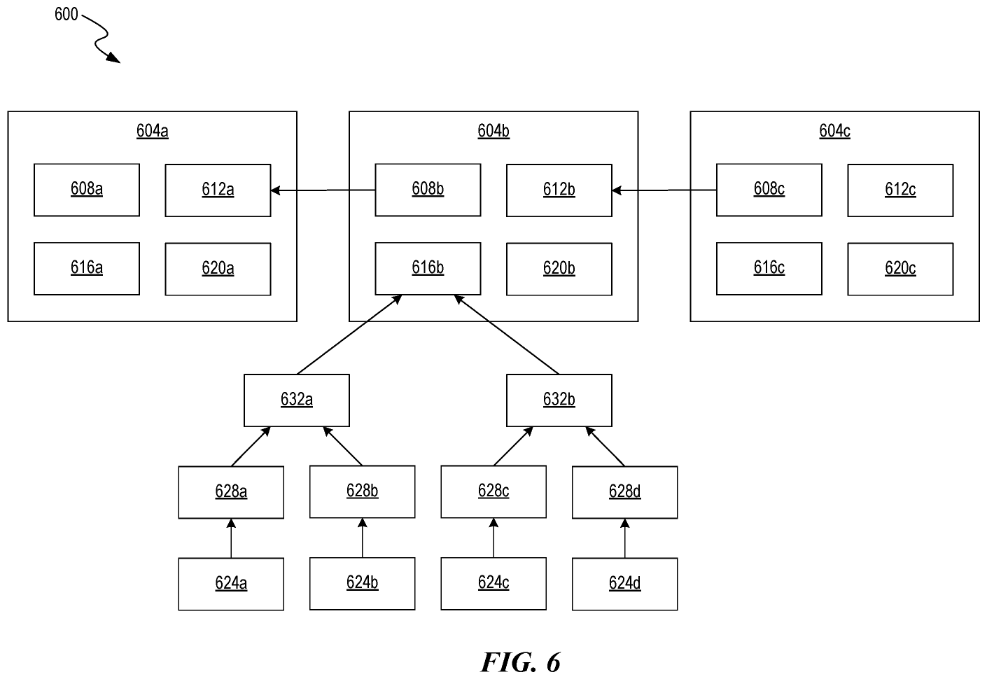

In some implementations, a digital wallet is an electronic device configured to store digital currency offline. For example, a hardware wallet can be an electronic device that stores virtual currency offline. In some implementations, a digital wallet includes a web-based interface and/or a community software application. For example, a hardware wallet can include one or more of the following interfaces to enable online transactions: a web-based interface, a community software application, a separate software wallet, and/or the like. In some embodiments, digital wallets 108, 114 only store, transmit, and/or receive virtual currency of a single type. In some embodiments, the digital wallets 108, 114 participate in digital transactions involving a variety of virtual currencies. Example transactions 624a-d are described in more detail with reference to FIG. 6.

A digital transaction (sometimes referred to as a “transaction”) takes place from beginning to end without need for cash or paper documents. A digital transaction can involve a single party (entity) or multiple participants (entities), and can also involve multiple forms of payment. For example, if a buyer pays via the Unified Payments Interface (UPI) on an e-commerce website, or buys from a seller and pays the seller through the UPI, both are digital payment transactions. Other modes of digital transactions include digital apps such as PayPal™ and mobile wallets. Cryptographic transactions are a type of digital transactions involving transfer of cryptocurrency. Cryptographic transactions enable cryptocurrency transfers to be anonymous, secure and trustless

The digital wallets 108, 114 can have security keys (e.g., private and/or public keys) and digital addresses for accessing funds from a distributed transaction database 104. As shown in FIG. 1, transaction manager 102 includes the transaction database 104. The transaction database 104 manages distributed ledger data (e.g., a blockchain) that is spread across multiple nodes (e.g., computational devices) on a peer-to-peer (P2P) network, where each node replicates and saves an identical copy of the ledger data and updates itself independently of other nodes. The transaction database 104 shown by FIG. 1 can be a single block or multiple blocks of a blockchain, with other blocks of the blockchain stored on nodes outside the transaction manager. The distributed processing provided by blockchains lacks a direct central authority, thus preventing a single point of failure. An example blockchain system 600 is illustrated and described in more detail with reference to FIG. 6.

The distributed transaction database 104 maintains a secure and decentralized record of transactions. The transaction database 104 facilitates fidelity and security of a record through distributed validation of actions taken in association with the transaction database 104 (e.g., “actions performed on the blockchain”). For example, the transaction database 104 collects information together in groups, sometimes referred to as “blocks,” that hold sets of information associated with virtual currency transactions. An example blockchain 604 and example blocks 604a-c are illustrated and described in more detail with reference to FIG. 6.

The blocks have certain storage capacities and, when filled, are closed and linked to the previously filled blocks in some implementations, forming a chain of data sometimes referred to as a blockchain. All new information (e.g., future virtual currency transactions) that follows a freshly added block is compiled into a newly formed block that will then also be added to the blockchain once filled. In some embodiments, each block is representative of an individual virtual currency transaction, while in other embodiments, each block is representative of a series of virtual currency transactions.

The transaction manager 102 receives requests to perform digital transactions using virtual currency. For example, a first transaction entity (e.g., transacting entity 106) associated with a first wallet 108 requests the transaction manager 102 to transmit funds to a second transacting entity (e.g., transacting entity 112) associated with a second wallet 114. The transaction manager 102 authorizes the transaction based on one or more security features (e.g., security tokens) including one or more identity verifiers 110, 116. As shown by FIG. 1, transacting entities 106, 112 are associated with identity verifiers 110, 116. The identity verifiers 110, 116 can include security tokens (e.g., one-time passwords, disconnected tokens, connected tokens, contactless tokens, single sign-on software tokens, programmable tokens, and/or the like) used to verify a user identity associated with a digital wallet. For example, identity verifier 110 represents an identity verification (e.g., through identity validation system 118) of an entity (e.g., user) associated with the digital wallet 108. Transacting entities 106, 112 can obtain corresponding identity verifiers 110, 116 from the identity validation system 118 or the transaction manager 102.

In some implementations, the identity validation system 118 includes an identity verification module (e.g., Know Your Customer (KYC) module 120) that facilitates identity verification associated with the digital wallets 108, 114. Other types of modules for other identity verification standards can be used instead of the KYC module 120. The identity validation system 118 can generate an identity verification token (e.g., identity verifier 110) using an identity verification standard. The identity verification standard can be KYC, electronic KYC (eKYC), video KYC, Pirani risk management, Onfido, Sumsub, iDenfy, Refinitiv World-Check Risk Intelligence, Ondato, Trulioo, or Persona. The eKYC standard includes an automated process through which companies can perform customer identity verification digitally. Hence, eKYC is an alternative to the traditional process that required physical documents.

The identity verifier 110 verifies an entity (e.g., entity 106) associated with the digital wallet 108. KYC guidelines include requirements that professionals make efforts to verify the identity, suitability, and risks involved with maintaining a relationship with an associated user. The procedures can fit within the broader scope of an institution's anti-money laundering (AML) policy.

The KYC module 120 creates and stores electronic records that contain KYC information, such as tax identification numbers, checking or savings account numbers, passport or driver license numbers, or any other suitable form of personal identification. Transaction manager 102 can communicate with the identity validation system 118 through the passage of identity verifiers 110, 116. For example, transaction manager 102 transmits a message that includes indications of the parties (e.g., digital wallets 108, 114) of a transaction to identity validation system 118 along with one or more identity verifiers 110, 116 that verify the authenticity of an identity associated with the wallets 108, 114. In response to receiving the message, the identity validation system 118 can access customer records based on the information included in the data message, and can retrieve a verification status (e.g., a KYC status). The identity validation system 118 can employ a processor to prepare a data message in response to the request received from the transaction manager 102.

In some implementations, a generated identity verification token is valid for a period of time specified by the identity verification token. The identity verification token can expire or be otherwise unusable after the period of time has passed. For example, the transacting entities 106, 112 may not need access to a new identity verifier from the identity validation system 118 for every transaction. The lifetime of each identity verifier 110, 116 can be configured to balance convenience and security of the transaction carried out by transaction manager 102. For example, an identifier verifier can be used for a temporal duration (e.g., an hour, a day a week, or a month). In some implementations, the identity verification token is valid for a number of digital transactions. For example, an identifier verifier is used for a number of transactions (e.g., one transaction, multiple transactions involving the same entities, or multiple transactions between different entities).

The digital transaction performed by the transaction manager 102 can involve the transfer of a digital token (e.g., a cryptocurrency token) from the transacting entity 106 to the transacting entity 112. For example, a digital token denoting a particular value stored in the digital wallet 108 is transferred to the digital wallet 114. The transferred token can result from a tokenization process. In some implementations, a tokenization process is performed that includes issuing a digital representation of an asset on a blockchain. The asset can be a physical asset (such as real estate or art), a business asset (such as equities or bonds), a nontangible asset (such as intellectual property), or even data. After the tokenization process is performed, the digital representation of the asset is stored in the form of one or more tokens in the digital wallet 108. In some examples, the stored one or more tokens are fungible, that is the one or more tokens are divisible and non-unique.

Prior to performing a transfer of the one or more tokens from the digital wallet 108 to the digital wallet 114, the transacting entity 106 associated with the digital wallet 108 obtains a verification of its identity from the identity validation system 118 in accordance with the methods disclosed herein. In some implementations, the identity validation system 118 generates and transmits an identity verification token to a computer device associated with the digital wallet 108. The identity verification token can include identifiers of the transacting entity 106, the transacting entity 112, the digital wallet 108, the digital wallet 114, and/or the asset that was tokenized. The identity verification token can be combined with the one or more fungible tokens to generate one or more non-fungible tokens that incorporate the verified identity of the transacting entity 106 and/or the transacting entity 112.

A request incorporating the identity verification token can be transmitted from the transacting entity 106 to the transaction manager 102 for performing an identity-verified transaction as described herein. The identity-verified transaction includes transferring the one or more non-fungible tokens from the digital wallet 108 to the digital wallet 114. Incorporating of the verified identity within the one or more non-fungible tokens therefore provides greater security for the transaction in accordance with the identity standards used to generate the identity verification token and the one or more non-fungible tokens. For example, a fraudulent transfer or theft of the one or more non-fungible tokens by a malicious entity could be prevented by examining the identity incorporated into the one or more non-fungible tokens, when the malicious entity tries to perform a transfer of the one or more non-fungible tokens.

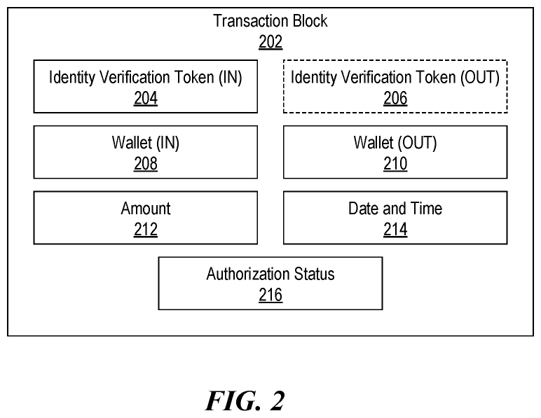

FIG. 2 is a block diagram that illustrates an example transaction block 202 that can implement aspects of the present technology. The transaction block 202 can be implemented as a general data structure. In some embodiments, the transaction block 202 can be stored as a block in a block chain. An example blockchain 604 and example blocks 604a-c are illustrated and described in more detail with reference to FIG. 6. The transaction block 202 represents an identity-incorporated virtual transaction, according to some embodiments. An identity-incorporated virtual transaction can be encapsulated as a transaction block. The transaction block 202 can encapsulate an individual transaction or multiple transactions (e.g., a series of transactions). Likewise, embodiments of example transaction block 202 can include different and/or additional components or can be arranged in different ways.

The transaction block 202 can include data received from a first transacting entity intending to enter into a transaction with a second transacting entity. For example, the first transacting entity can request transmitting of a virtual currency to the second transacting entity. Example transacting entities 106, 112 are illustrated and described in more detail with reference to FIG. 1. As shown by FIG. 2, transaction block 202 includes an identity verification token (IN) 204 and an identifier of a digital wallet (IN) 208 corresponding to a first entity providing funds into (“IN”) a transaction. An example digital wallet 760 is illustrated and described in more detail with reference to FIG. 7B. Example transactions 624a-d are described in more detail with reference to FIG. 6. An identifier of the wallet (OUT) 210 is associated with an entity receiving funds out of (“OUT”) the transaction. The transaction block 202 can include an amount 212 of an associated virtual currency, an intended date and time 214 associated with the transaction, an authorization status 216, and optionally an identity verification token (OUT) 206 linked to the wallet (OUT) 210.

The identity verification token (IN) 204 verifies and authorizes the identity of an entity associated with wallet (IN) 208 to participate in the associated transaction according to an identity verification standard (e.g., a KYC evaluation standard). The wallet (IN) 208 identifier can include a reachable address to the wallet (IN) 208 (e.g., a username, a screenname, a barcode, a quick response (QR) code, and/or the like), and/or security keys (e.g., a public and/or private key associated with the authorization and connection of the wallet (IN) 208 to a transaction) corresponding to the wallet (IN) 208.

The amount 212 specifies one or more currency types and an amount of each virtual currency transacted. The date and time 214 indicates a time a transaction is planned to occur or has occurred. The authorization status 216 includes one or more of: (i) an indication of whether wallet (IN) 208 is properly identified and/or may participate in a particular transaction, (ii) an indication of whether wallet (OUT) 210 is properly identified and/or may participate in the transaction, (iii) an indication that a user identity associated with wallet (IN) 208 is properly identified and/or is authorized to participate in the transaction, and (iv) an indication that a user identity associated with wallet (OUT) 210 is properly identified and/or is authorized to participate in the transaction.

In some embodiments, the transaction block 202 includes a single identity verification token 204 for either the sender (IN) or the receiver (OUT) of funds. In some embodiments, an independent identity verification token is used for each participating entity in the transaction. The identity verification token 204 can be specific to a single transaction or a group of transactions (e.g., an identity verification token can be valid for only a single transaction or a group of transactions). In some implementations, an identity verification token is generated using identifiers of a first digital wallet and a second digital wallet, an amount of virtual currency, and/or a date and time of a digital transaction. For example, the identity verification token 204 is generated using data associated with a transaction, such as, the amount 212, the date and time 214, the identifier of the wallet (IN) 208, or the identifier of the wallet (OUT) 210. In some examples, the identity verification token 204 is linked to the digital wallet (IN) 208, and is passed through to the transaction block 202 to verify an entity's identity agnostic to the particular transaction.

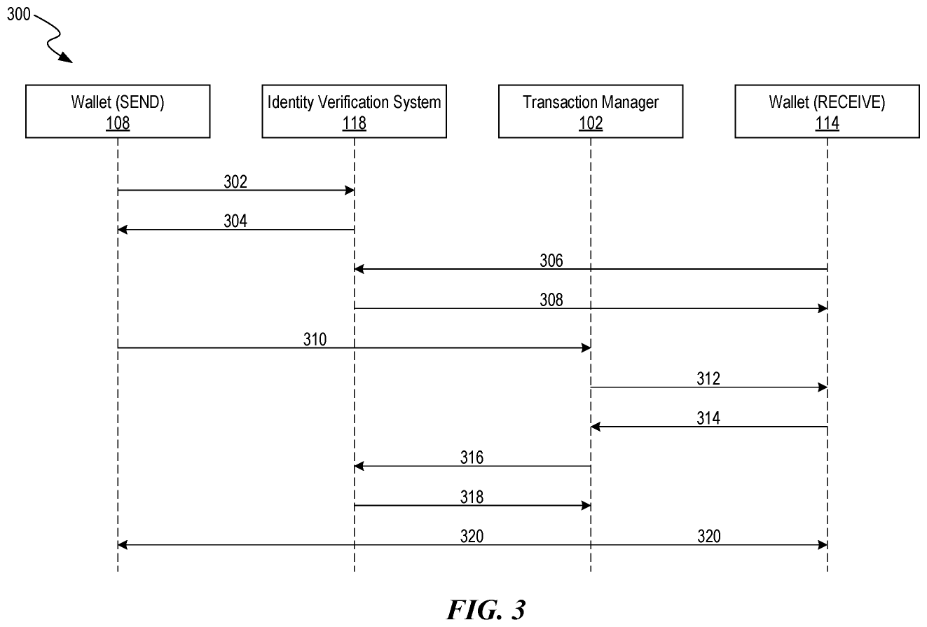

FIG. 3 is a flow diagram that illustrates an example process 300 according to aspects of the present technology. In some implementations, the process is performed by the identity validation system 118 illustrated and described in more detail with reference to FIG. 1. In some implementations, the process is performed by a computer system, e.g., example computer system 400 illustrated and described in more detail with reference to FIG. 4. Particular entities, for example, the transaction manager 102, perform some or all of the steps of the process in other implementations. The transaction manager 102 is illustrated and described in more detail with reference to FIG. 1. Likewise, implementations can include different and/or additional steps or can perform the steps in different orders.

FIG. 3 shows operations of a digital wallet (“wallet (SEND) 108”) configured to transmit virtual currency in a transaction and a digital wallet (“wallet (RECEIVE) 114”) configured to store virtual currency received in a transaction. Example transactions 624a-d are described in more detail with reference to FIG. 6. The transaction manager 102 facilitates virtual currency transactions and the identity verification system 118 verifies entities and validates tokens associated with participating entities of a transaction based on an identity verification (sometimes referred to as a “customer identification standard,” such as a KYC standard. Specifically, process 300 carries out a transaction between a first transacting entity associated with the wallet (SEND) 108 and a second transacting entity associated with the wallet (RECEIVE) 114.

At 302, the identify verification system 118 receives a verification request from the wallet (SEND) 108. For example., a computer device associated with the wallet (SEND) 108 transmits the request to the identify verification system 118. In some implementations, identification information used includes at least one of a tax identification number, a checking or savings account number, a passport number, or a driver's license number. For example, the request can include user identifying information such as a personal ID number, a tax identification number, a passport number, a driver's license number, a sovereign related identification number, and/or the like associated with an entity associated with the wallet (SEND) 108. In response, the identity verification system 118, generates an identity verification token based on the received identifying information of the entity and a customer identification standard (sometimes referred to as an identity verification standard).

The customer identification standard can be a Know Your Customer (KYC) identity evaluation standard. In some examples, the identify verification system 118 verifies an identity of an entity before the entity is associated with a digital wallet. After the identity verification is performed and an identity verification token is obtained, the verified entity can be associated with one or digital wallets using the identity verification token. In some examples, the identify verification system 118 verifies the identity of an entity after the entity has already been associated with a digital wallet.

KYC standards involve establishing sufficient understanding of a user for authorization. KYC standards can include a due diligence process to verify customer identity, and assess and monitor customer risk. By verifying a customer's identity and intentions and then monitoring transaction patterns, institutions and sovereign authorities can more accurately pinpoint suspicious activities. To meet KYC requirements, the entity (e.g., user) associated with the wallet (SEND) 108 provides proof of their identity and address, such as facial verification, biometric verification, and/or document verification. Examples of KYC documents include a passport, a driver's license, or a utility bill. KYC can be beneficial for determining customer risk and whether a customer meets an identity verification standard to participate in a virtual currency transaction. Compliance with KYC can be required to participate in virtual currency transactions as a matter of law, for example, to comply with Anti-Money Laundering (AML) laws. Managers of transactions may be required under law to ensure transacting entities are not engaging in criminal activities while using their services.

At 304, the identity verification system 118 transmits the identity verification token to the computer device associated with the wallet (SEND) 108. The identity verification token verifies the identity of the entity associated with the wallet (SEND) 108 or otherwise enables the entity associated with the wallet (SEND) 108 to participate in virtual currency transactions.

At 306, the identify verification system 118 receives a verification request from a computer device associated with an entity associated with the wallet (RECEIVE) 114. The request is for verifying an identity of the entity associated with the wallet (RECEIVE) 114. The identify verification system 118 generates an identity verification token verifying the identity of the entity associated with the wallet (RECEIVE) 114.

At 308, the identity verification system 118 transmits the identity verification token to the entity associated with the wallet (RECEIVE) 114. An example digital wallet 760 is illustrated and described in more detail with reference to FIG. 7B. In some implementations, the identity verification process to generate the identity verification token includes authentication of the identity of an individual by a server or client performed using a username and password. Example inputs for the identity verification process include scans of identification cards, retina scans, voice recognition, and fingerprints. Multiple authentication factors can be used to prove identity based on the premise that an unauthorized actor is unlikely to be able to supply the factors required for access. If, in an authentication attempt, at least one of the components is missing or supplied incorrectly, the user's identity is not established with sufficient certainty. For example, the multiple verification factors used by the identity verification system 118 can include a security token (e.g., USB stick), a bank card, a key, a password, a personal identification number (PIN), a Personal Unlocking Key (PUK), or biometrics, such as a fingerprint, eye iris, voice, typing speed, or pattern in key press intervals.

At 310, the transaction manager 102 receives a transaction request from a computer device associated with the wallet (SEND) 108. The transaction request can specify a virtual currency transaction between the wallet (SEND) 108 and the wallet (RECEIVE) 114. The transaction request includes identity verification token(s) linked to the wallet (SEND) 108 and/or the wallet (RECEIVE) 114. For example, the transaction request includes a data block of data such as the transaction block 202 illustrated and described in more detail with reference to FIG. 2. The transaction manager 102 processes the transaction request to determine whether identities of the transacting entities have been verified.

At 312, the transaction manager 102 optionally requests identity verification from the wallet (RECEIVE) 114. In some implementations, a digital transaction is linked to the wallet (SEND) 108 and the wallet (RECEIVE) 114 by a cryptographic key. The key is a piece of information, usually a string of numbers or letters that are stored in a file, which, when processed through a cryptographic algorithm, can encode or decode cryptographic data. The key can be generated from identifiers of the wallet (SEND) 108 and the wallet (RECEIVE) 114, and/or information identifying transacting entities associated with the wallet (SEND) 108 and the wallet (RECEIVE) 114.

In response to the transaction manager 102 requesting an identity verification from the wallet (RECEIVE) 114, at 314 the entity associated with the wallet (RECEIVE) 114 transmits an identity verification token to the transaction manager 102. In some implementations, the identity verification system 118 itself performs digital transactions. For example, the identity verification system 118 receives a transaction request from a computer device associated with the wallet (SEND) 108. The transaction request is for performing a digital transaction linked to the wallet (SEND) 108. The transaction request includes an identity verification token. The identity verification system 118 validates the identity verification token using the identity verification standard, and performs the digital transaction linked to the wallet (SEND) 108.

At 316, the identity verification system 118 receives a validation request from the transaction manager 102 to validate the identity verification tokens received by the transaction manager 102 from the transacting entities associated with the particular transaction.

At 318, the identity verification system 118 validates the entities based on their identity verification tokens. The identity verification system 118 transmits identity validation data authorizing the transaction manager 102 to carry out the particular transaction. The transaction manager 102 carries out the transaction by moving an appropriate amount of a virtual currency from the wallet (SEND) 108 to the wallet (RECEIVE) 114.

In some alternate implementations, a first entity 106 and/or a second entity 112 submit a verification request to the transaction manager 102 for a digital transaction. The verification request includes first identification information identifying the first entity 106 and second identification information identifying the second entity 112. The first entity 106 is associated with a first digital wallet 108, and the second entity 112 is associated with a second digital wallet 114. The verification request is associated with a digital transaction between the first entity 105 and the second entity 112. The transaction manager 102 receives an identity verification token from the identity verification system 118 verifying the first entity 106 and the second entity 112. The identity verification token is generated based on the first identification information and the second identification information. In response to receiving the identity verification token, the digital transaction is linked to the first digital wallet 108 and the second digital wallet 114 using the identity verification token.

At 320, the transaction manager 102 performs the transaction and stores the particular transaction on a ledger (e.g., a blockchain) by transmitting completion data of the transaction to each node of a distributed transaction database (e.g., distributed transaction database 104).

FIG. 4 is a block diagram of a computer system 400 storing instructions that can be used to implement aspects of the present technology. Computer system 400 can correspond to a processing device within an identity-incorporated virtual transaction system. An example of such a system 100 is illustrated and described in more detail with reference to FIG. 1. Components of computer system 400 can be used to implement the transaction manager 102, computer devices associated with the transacting entities 106, 112, and/or the identity validation system 118. The computer system 400 can be included within a data center that supports virtualization. Virtualization within a data center results in a physical system being virtualized using virtual machines (VMs) to consolidate the data center infrastructure and increase operational efficiencies. Likewise, embodiments of the computer system 400 can include different and/or additional components or can be connected in different ways.

A VM is a program-based emulation of computer hardware. A VM can be mapped to a particular computer architecture and be associated with computer hardware resources, such as hard disks or other such memory. A VM can emulate a physical computing environment, while requests for a hard disk or memory are managed by a virtualization layer of a host machine to translate these requests to the underlying physical computing hardware resources. This type of virtualization results in multiple VMS sharing physical resources.

The computer system 400 can take any suitable physical form. For example, the computer system 800 can share a similar architecture as that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computer system 400. In some implementation, the computer system 400 can be an embedded computer system, a system-on-chip (SOC), a single-board computer system (SBC) or a distributed system such as a mesh of computer systems or include one or more cloud components in one or more networks. Where appropriate, one or more computer systems 400 can perform operations in real-time, near real-time, or in batch mode.

In certain implementations, computer system 400 is connected (e.g., via a network, such as a Local Area Network (LAN), an intranet, an extranet, or the Internet) to other computer systems. Computer system 400 can operate in the capacity of a server or a client computer in a client-server environment, or as a peer computer in a peer-to-peer or distributed network environment. Computer system 400 may be implemented in a personal computer (PC), a tablet PC, a set-top box (STB), a Personal Digital Assistant (PDA), a cellular telephone, a web appliance, a server, a network router, switch or bridge, or any device capable of executing a set of instructions (sequential or otherwise) that specify actions to be taken by that device. Further the term “computer” as used herein includes any collection of computers that individually or jointly execute a set (or multiple sets) of instructions to perform any one or more of the methods described herein. The computer system 400 includes a processing device 402, a volatile memory 404 (e.g., random access memory (RAM)), a non-volatile memory 406 (e.g., read-only memory (ROM) or electrically-erasable programmable ROM (EEPROM)) and a data storage device 416 that can communicate with each other via a bus 408

Processing device 402 can include one or more computer hardware processors such as a general-purpose processor (e.g., a complex instruction set computing (CISC) microprocessor, a reduced instruction set computing (RISC) microprocessor, a very long instruction word (VLIW) microprocessor, a microprocessor implementing other types of instruction sets, or a microprocessor implementing a combination of types of instruction sets) or a specialized processor (e.g., an application-specific integrated circuit (ASIC), a field-programmable gate array (FPGA), a digital signal processor (DSP), or a network processor).

Computer system 400 can further include a network interface device 422. Computer system 400 can include a video display unit 410 (e.g., an LCD), an alphanumeric input device 412 (e.g., a keyboard), a cursor control device 414 (e.g., a mouse), and a signal generation device 420. Data storage device 416 can include a non-transitory computer-readable storage medium 424 that stores instructions 426 encoding any one or more of the methods or functions described herein, including instructions for an identity-incorporated virtual transaction system. Instructions 426 can also reside, completely or partially, within volatile memory 404 and/or processing device 402 during execution thereof by computer system 400. Hence, volatile memory 404 and processing device 402 can also constitute machine-readable storage media.

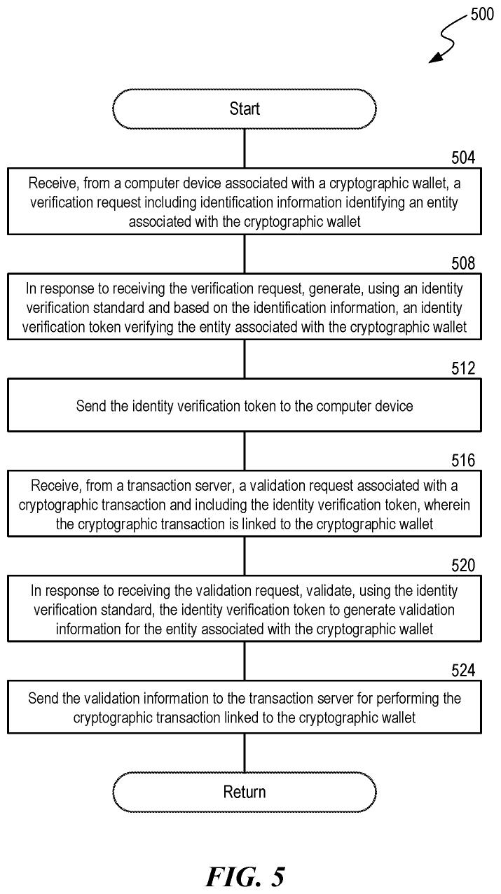

FIG. 5 is a flow diagram that illustrates an example process 500 according to aspects of the present technology. In some implementations, the process 500 is performed by the transaction manager 102 or identity verification system 118 illustrated and described in more detail with reference to FIG. 1. In some implementations, the process is performed by a computer system, e.g., example computer system 400 illustrated and described in more detail with reference to FIG. 4. Particular entities, for example, a computer device associated with an entity perform some or all of the steps of the process in other implementations. Likewise, implementations can include different and/or additional steps or can perform the steps in different orders.

At 504, the identity verification system 118 receives a verification request from a computer device associated with a cryptographic wallet. The computer device can be associated with entity 106 described in more detail with reference to FIG. 1. The cryptographic wallet is similar to the wallet 108 illustrated and described in more detail with reference to FIG. 1. The verification request includes identification information identifying an entity associated with the cryptographic wallet. The cryptographic wallet can be a software wallet or a hardware wallet. An example digital wallet 760 is illustrated and described in more detail with reference to FIG. 7B.

At 508, in response to receiving the verification request, the identity verification system 118 generates, using an identity verification standard (e.g., the KYC standard) an identity verification token based on the identification information. The identity verification token verifies the entity associated with the cryptographic wallet. In some implementations, the identity verification token is generated using biometric data of an entity, a digital upload of documentation, multi-factor authentication, digital breadcrumbs of the entity, a one-time password (OTP), and/or a trusted data source.

The digital upload can be of a passport or driver's license from a user's smartphone. The digital breadcrumbs refer to a trail of information, such as the Web pages the entity visits, the links that the entity clicks on, location and browser history, cookies, etc. The identity verification token can be a onetime password, a disconnected token, a connected token, a contactless token, a single sign-on software token, or a programmable token. A disconnected token is a digital security token that doesn't connect physically or logically to a computer. For example, a desktop application that transmits a text message to a cellphone, in which a user must input a login, is using a disconnected token. A connected token is physically connected to a computer with which a user is authenticating. Connected tokens automatically transmit the authentication information to a computer device once a physical connection is made, eliminating the need for the user to manually enter the authentication information.

At 512, the identity verification system 118 transmits the identity verification token to the computer device. For example, the identity verification token can be used for performing a cryptographic transaction linked to the cryptographic wallet. Example transactions 624a-d are described in more detail with reference to FIG. 6.

At 516, the identity verification system 118 receives a validation request from a transaction server. The transaction server is the same as or similar to the transaction manager 102 illustrated and described in more detail with reference to FIG. 1. In some implementations, the transaction server and the identity verification system 118 are part of the same computer system. The validation request is associated with a cryptographic transaction and includes the identity verification token. The cryptographic transaction is linked to the cryptographic wallet.

At 520, in response to receiving the validation request, the identity verification system 118 validates the identity verification token using the KYC standard to generate validation information for the entity associated with the cryptographic wallet.

At 524, the identity verification system 118 transmits the validation information to the transaction server for performing the cryptographic transaction linked to the cryptographic wallet. After performing the cryptographic transaction, the cryptographic transaction is stored in a block of a block chain. An example transaction block 202 is illustrated and described in more detail with reference to FIG. 2. An example blockchain 604 is illustrated and described in more detail with reference to FIG. 6. In some implementations, the block includes the identity verification token, an identifier of the cryptographic wallet, an amount of cryptocurrency processed by the cryptographic transaction, and/or a date and time of the cryptographic transaction. The block can include an address of the wallet, a username of the wallet, a screenname of the wallet, a barcode of the wallet, and/or a quick response (QR) code of the wallet.

FIG. 6 is a block diagram illustrating components of at least a portion of an exemplary blockchain system 600, in accordance with one or more embodiments of this disclosure. Blockchain system 600 includes blockchain 604. In embodiments, the blockchain 604 is a distributed ledger of transactions (e.g., a continuously growing list of records, such as records of transactions for digital assets such as cryptocurrency, bitcoin, or electronic cash) that is maintained by a blockchain system 600. For example, the blockchain 604 is stored redundantly at multiple nodes (e.g., computers) of a blockchain network. Each node in the blockchain network can store a complete replica of the entirety of blockchain 604. In some embodiments, the blockchain system 600 implements storage of an identical blockchain at each node, even when nodes receive transactions in different orderings. The blockchain 604 shown by FIG. 6 includes blocks such as block 604a, block 604b, and/or block 604c. Likewise, embodiments of the blockchain system 600 can include different and/or additional components or be connected in different ways.

The terms “blockchain” and “chain” are used interchangeably herein. In embodiments, the blockchain 604 is a distributed database that is shared among the nodes of a computer network. As a database, the blockchain 604 stores information electronically in a digital format. The blockchain 604 can maintain a secure and decentralized record of transactions (e.g., transactions such as transaction 624a and/or transaction 624b). For example, the ERC-721 or ERC-1155 standards are used for maintaining a secure and decentralized record of transactions. The blockchain 604 provides fidelity and security for the data record. In embodiments, blockchain 604 collects information together in groups, known as “blocks” (e.g., blocks such as block 604a, block 604b, and/or block 604c) that hold sets of information.

The blockchain 604 structures its data into chunks (blocks) (e.g., blocks such as block 604a, block 604b, and/or block 604c) that are strung together. Blocks (e.g., block 604c) have certain storage capacities and, when filled, are closed and linked to a previously filled block (e.g., block 604b), forming a chain of data known as the “blockchain.” New information that follows a freshly added block (e.g., block 604b) is compiled into a newly formed block (e.g., block 604c) that will then also be added to the blockchain 604 once filled. The data structure inherently makes an irreversible timeline of data when implemented in a decentralized nature. When a block is filled, it becomes a part of this timeline of blocks. Each block (e.g., block 604a) in the blockchain system 600 is given an exact timestamp (e.g., timestamp 612a) when it is added to the blockchain system 600. In the example of FIG. 6, blockchain system 600 includes multiple blocks. Each of the blocks (e.g., block 604a, block 604b, block 604c) can represent one or multiple transactions and can include a cryptographic hash of the previous block (e.g., previous hashes 608a-c), a timestamp (e.g., timestamps 612a-c), a transactions root hash (e.g., 616a-c), and a nonce (e.g., 620a-c). A transactions root hash (e.g., transactions root hash 616b) indicates the proof that the block 604b contains all the transactions in the proper order. Transactions root hash 616b proves the integrity of transactions in the block 604b without presenting all transactions.

In embodiments, the timestamp 612a-c of each of corresponding blocks of block 604a, block 604b, block 604c includes data indicating a time associated with the block. In some examples, the timestamp includes a sequence of characters that uniquely identifies a given point in time. In one example, the timestamp of a block includes the previous timestamp in its hash and enables the sequence of block generation to be verified.

In embodiments, nonces 620a-c of each of corresponding blocks of block 604a, block 604b, block 604c include any generated random or semi-random number. The nonce can be used by miners during proof of work (PoW), which refers to a form of adding new blocks of transactions to blockchain 604. The work refers to generating a hash that matches the target hash for the current block. For example, a nonce is an arbitrary number that miners (e.g., devices that validate blocks) can change in order to modify a header hash and produce a hash that is less than or equal to the target hash value set by the network.

As described above, each of blocks of block 604a, block 604b, block 604c of blockchain 604 can include respective block hash, e.g., transactions root hash 616a, transactions root hash 616b, and transactions root hash 616c. Each of block hashes 616a-c can represent a hash of a root node of a Merkle tree for the contents of the block (e.g., the transactions of the corresponding block). For example, the Merkle tree contains leaf nodes corresponding to hashes of components of the transaction, such as a reference that identifies an output of a prior transaction that is input to the transaction, an attachment, and a command. Each non-leaf node can contain a hash of the hashes of its child nodes. The Merkle tree can also be considered to have each component as the leaf node with its parent node corresponding to the hash of the component.

In the example of FIG. 6, block 604b records transactions 624a-d. Each of the leaf nodes 628a-d contain a hash corresponding to transactions 624a-d respectively. As described above, a hash (e.g., the hash in leaf node such as node 628a) can be a hash of components of a transaction (e.g., transaction 624a), for example, a reference that identifies an output of a prior transaction that is input to the transaction 624a, an attachment, and a command. Each of the non-leaf nodes of node 632a and node 632b can contain a hash of the hashes of its child nodes (e.g., leaf nodes such as node 628a and node 628b). In this example, node 632a can contain a hash of the hashes contained in node 628a, node 628b and node 632b can contain a hash of the hashes contained in node 628c, node 628d. The root node, which includes (e.g., contains) transactions root hash 616b, can contain a hash of the hashes of child nodes 632a-b.

A Merkle tree representation of a transaction (e.g., transaction 624a) allows an entity needing access to the transaction 624a to be provided with only a portion that includes the components that the entity needs. For example, if an entity needs only the transaction summary, the entity can be provided with the nodes (and each node's sibling nodes) along the path from the root node to the node of the hash of the transaction summary. The entity can confirm that the transaction summary is that used in the transaction 624a by generating a hash of the transaction summary and calculating the hashes of the nodes along the path to the root node. If the calculated hash of the root node matches the hash of node 628a of the transaction 624a, the transaction summary is confirmed as the one used in the transaction. Because only the portion of the Merkle tree relating to components that an entity needs is provided, the entity will not have access to other components. Thus, the confidentiality of the other components is not compromised.

To transfer ownership of a digital asset, such as a bitcoin, using the blockchain system 600, a new transaction, such as one of transactions 624a-d, is generated and added to a stack of transactions in a block, e.g., block 604b. To record a transaction in a blockchain, each party and asset involved with the transaction needs an identification that is verified by a digital token. The first user (i.e., the current owner) creates a transaction (e.g., transaction 624a) against the asset that indicates that the transaction 624a is a transfer of ownership and outputs a token identifying the second user as the next owner and a token identifying the asset. The transaction 624a is signed by the private key of the first user (i.e., the current owner), and the transaction 624a is evidence that the second user is now the new current owner and that ownership has been transferred from the first to the second user.

The transaction 624a (e.g., a new transaction), which includes the public key of the new owner (e.g., a second user to whom a digital asset is assigned ownership in the transaction), is digitally signed by the first user with the first user's private key to transfer ownership to the second user (e.g., new owner), as represented by the second user public key. The signing by the owner of the bitcoin is an authorization by the owner to transfer ownership of the bitcoin to the new owner via the transaction 624a (e.g., the new transaction). Once the block is full, the block is “capped” with a block header, that is, a hash digest of all the transaction identifiers within the block. The block header is recorded as the first transaction in the next block in the chain, creating a mathematical hierarchy called the “blockchain.” To verify the current owner, the blockchain 604 of transactions can be followed to verify each transaction from the first transaction to the last transaction. The new owner need only have the private key that matches the public key of the transaction that transferred the bitcoin. The blockchain creates a mathematical proof of ownership in an entity represented by a security identity (e.g., a public key), which in the case of the bitcoin system is pseudo-anonymous.

Additionally, in some embodiments, the blockchain system 600 uses one or more smart contracts to enable more complex transactions. A smart contract includes computer code implementing transactions of a contract. The computer code can be executed on a secure platform (e.g., an Ethereum platform, which provides a virtual machine) that supports recording transactions (e.g., 624a-d) in blockchains. For example, a smart contract can be a self-executing contract with the terms of the agreement between buyer and seller being directly written into lines of code. The code and the agreements contained therein exist across a distributed, decentralized blockchain network.

In addition, the smart contract can itself be recorded as a transaction 624a in the blockchain 604 using a token that is a hash of node 628a of the computer code so that the computer code that is executed can be authenticated. When deployed, a constructor of the smart contract executes, initializing the smart contract and its state. The state of a smart contract is stored persistently in the blockchain 604. When a transaction 624a is recorded against a smart contract, a message is sent to the smart contract, and the computer code of the smart contract executes to implement the transaction (e.g., debit a certain amount from the balance). The computer code ensures that all the terms of the contract are complied with before the transaction 624a is recorded in the blockchain 604.

For example, a smart contract can support the transfer of an asset. The inputs to a smart contract to sell an asset can be tokens identifying the seller, the buyer, the asset, and the transfer price in U.S. dollars or cryptocurrency. The computer code is used to ensure that the seller is the current owner of the asset and that the buyer has sufficient funds. The computer code records a transaction (e.g., transaction 624a) that transfers the ownership of the asset to the buyer and a transaction (e.g., transaction 624b) that transfers the transfer price from the buyer to the seller. If either of transaction 624a or transaction 624b is not successful, neither transaction is recorded.

When a message is sent to a smart contract to record a transaction 624a, the message is sent to each node that maintains a replica of the blockchain 604. Each node executes the computer code of the smart contract to implement the transaction 624a. For example, if a hundred nodes each maintain a replica of the blockchain 604, the computer code executes at each of the hundred nodes. When a node completes execution of the computer code, the result of the transaction 624a is recorded in the blockchain 604. The nodes employ a consensus algorithm to decide which transactions (e.g., transaction 624c) to keep and which transactions (e.g., transaction 624d) to discard. Although the execution of the computer code at each node helps ensure the authenticity of the blockchain 604, large amounts of computer resources are required to support such redundant execution of computer code.

Although blockchains can effectively store transactions 624a-d, the large amount of computer resources, such as storage and computational power, needed to maintain all the replicas of the blockchain can be problematic. To overcome this problem, some systems for storing transactions 624a-d do not use blockchains, but rather have each party to a transaction maintain its own copy of the transaction 624a. One such system is the Corda™ system developed by R3™ that provides a decentralized distributed ledger platform in which each participant in the platform has a node (e.g., computer system) that maintains its portion of the distributed ledger.

When parties agree on the terms of a transaction 624a, a party submits the transaction 624a to a notary, which is a trusted node, for notarization. The notary maintains a consumed output database of transaction outputs that have been input into other transactions. When a transaction 624a is received, the notary checks the inputs to the transaction 624a against the consumed output database to ensure that the outputs that the inputs reference have not been spent. If the inputs have not been spent, the notary updates the consumed output database to indicate that the referenced outputs have been spent, notarizes the transaction 624a (e.g., by signing the transaction or a transaction identifier with a private key of the notary), and transmits the notarized transaction to the party that submitted the transaction 624a for notarization. When the party receives the notarized transaction, the party stores the notarized transaction and provides the notarized transaction to the counterparties.

In embodiments, a notary is a non-validating notary or a validating notary. When a non-validating notary is to notarize a transaction (e.g., transaction 624b), the non-validating notary determines that the prior output of a prior transaction (e.g., transaction 624a), that is, the input of a current transaction, e.g., transaction 624b, has not been consumed. If the prior output has not been consumed, the non-validating notary notarizes the transaction 624b by signing a hash of node 628b of the transaction. To notarize a transaction 624b, a non-validating notary needs only the identification of the prior output (e.g., the hash of node 628a of the prior transaction (e.g., transaction 624a) and the index of the output) and the portion of the Merkle tree needed to calculate the hash of node 628b of the transaction 624b.

As described herein, in some embodiments, the blockchain system 600 uses one or more smart contracts to enable more complex transactions. For example, a validating notary validates a transaction (e.g., transaction 624d), which includes verifying that prior transactions 624a-c in a backchain of transactions are valid. The backchain refers to the collection of prior transactions (e.g., transaction 624c) of a transaction 624d, as well as prior transactions of transaction 624a, transaction 624b, and transaction 624c, and so on. To validate a transaction 624d, a validating notary invokes validation code of the transaction 624d. In one example, a validating notary invokes validation code of a smart contract of the transaction 624d. The validation code performs whatever checks are needed to comply with the terms applicable to the transaction 624d. This checking can include retrieving the public key of the owner from the prior transaction (e.g., transaction 624c) (pointed to by the input state of the transaction 624d) and checks the signature of the transaction 624d, ensuring that the prior output of a prior transaction that is input has not been consumed, and checking the validity of each transaction (e.g., transaction 624c) in the backchain of the transactions. If the validation code indicates that the transaction 624d is valid, the validating notary notarizes the transaction 624d and records the output of the prior transaction (e.g., transaction 624c) as consumed.

In some examples, to verify that the transactions 624a-d in a ledger stored at a node are correct, the blocks, e.g., block 604a, block 604b, block 604c in the blockchain 604 can be accessed from oldest block (e.g., block 604a) to newest block (e.g., block 604c), generating a new hash of the block 604c and comparing the new hash to the hash 608c generated when the block 604c was created. If the hashes are the same, then the transactions in the block are verified. In one example, the Bitcoin system also implements techniques to ensure that it would be infeasible to change a transaction 624a and regenerate the blockchain 604 by employing a computationally expensive technique to generate a nonce 620b that is added to the block when it is created. A bitcoin ledger is sometimes referred to as an Unspent Transaction Output (“UTXO”) set because it tracks the output of all transactions that have not yet been spent.

In some embodiments, a self-sovereign identity (SSI) approach to digital identity is used that gives individuals control over the information they use to prove who they are to websites, services, and applications across the web. In an SSI system, the user accesses services in a streamlined and secure manner, while maintaining control over the information associated with their identity. SSI addresses the difficulty of establishing trust in an interaction. In order to be trusted, one party in an interaction will present credentials to the other parties, and those relying on parties can verify that the credentials came from an issuer that they trust. In this way, the verifier's trust in the issuer is transferred to the credential holder. This basic structure of SSI with three participants is sometimes called “the trust triangle”. For an identity system to be self-sovereign, users control the verifiable credentials that they hold and their consent is required to use those credentials. This reduces the unintended sharing of users' personal data.

In an SSI system, holders generate and control unique identifiers called decentralized identifiers. Most SSI systems are decentralized, where the credentials are managed using crypto wallets and verified using public-key cryptography anchored on a distributed ledger. The credentials may contain data from an issuer's database, a social media account, a history of transactions on an e-commerce site, or attestation from friends or colleagues.

FIG. 7A is a drawing illustrating an application of a hash function 700, in accordance with one or more embodiments of this disclosure. The process shown by FIG. 7A uses a hash algorithm to generate a token or perform a cryptographic transaction on a blockchain. The transaction shown by FIG. 7 can be made more secure using the identity verification methods described in more detail with reference to FIGS. 1-3 and 6. An example blockchain 604, e.g., as shown in FIG. 7A, is also illustrated and described in more detail with reference to FIG. 6. The process 700 can be performed by a computer system such as that described with reference to FIG. 4 and/or by nodes of the blockchain 604. Some embodiments include different and/or additional steps or perform steps in different orders.

In embodiments, a digital message, electronic art, a digital collectible, any other form of digital content, or a combination thereof (e.g., digital content 704a) can be hashed using hashing algorithm 708a. The hashing algorithm 708a (sometimes referred to as a “hash function”) can be a function used to map data of arbitrary size (e.g., digital content 704a) to fixed-size values (e.g., hash of values 712a). The values 712a that are returned by the hashing algorithm 708a can be called hash values, hash codes, digests, or hashes. The values 712a can be used to index a fixed-size table called a hash table. A hash table, also known as a hash map, is a data structure that implements an associative array or dictionary, which is an abstract data type that maps keys (e.g., digital content 704a) to values 712a.

The output of the hashed digital content (e.g., hash of values 712a) can be inserted into a block (e.g., block 604c) of the blockchain 604 (e.g., comprising blocks 604a-b). The block 604c can include, among other things, information such as timestamp 612c. In order to verify that the block 604c is correct, a new hash 712b is generated by applying hashing algorithm 708b to the digital content 704b. The new hash 712b is compared to the hash of values 712a in the blockchain 604 at comparison step 716. If the new hash 712b is the same as the hash of values 712a of the block 604c, the comparison yields an indication that they match. For example, the decision 720 can indicate that the hashes of values 712a-b are the same or not. The hashes can be indicated to be the same if the characters of the hash match. The hashing algorithms 708a-b can include any suitable hashing algorithm. Examples include Message Digest 5 (MD5), Secure Hashing Algorithm (SHA) and/or the likes.

The methods for performing digital transactions using identity verification disclose herein can be applied to the generation, purchase and transfer of NFTs. For example, components of the process 700 can generate or validate an NFT, which is a cryptographic asset that has a unique identification code and metadata that uniquely identifies the NFT. In one example, the digital content 704a can be hashed and minted to generate an NFT, or the digital content 704a can represent an NFT that is verified using the process 700 and the digital content 704b. An NFT can include digital data stored in the blockchain 604. The ownership of an NFT is recorded in the blockchain 604 and transferrable by an owner, allowing the NFT to be sold and traded. The NFT contains a reference to digital files such as photos, videos, or audio (e.g., digital content 704a). Because NFTs are uniquely identifiable assets, they differ from cryptocurrencies, which are fungible. In particular, NFTs function like cryptographic tokens, but unlike cryptocurrencies such as Bitcoin™ or Ethereum™, NFTs are not mutually interchangeable, and so are not fungible.

The NFT can be associated with a particular digital or physical asset such as images, art, music, and sport highlights and can confer licensing rights to use the asset for a specified purpose. As with other assets, NFTs are recorded on a blockchain when a blockchain 604 concatenates records containing cryptographic hashes—sets of characters that identify a set of data—onto previous records, creating a chain of identifiable data blocks such as block 604a, block 604b, block 604c, and block 604d. A cryptographic transaction process enables authentication of each digital file by providing a digital signature that tracks NFT ownership. In embodiments, a data link that is part of the NFT records points to details about where the associated art is stored.

Minting an NFT can refer to the process of turning a digital file (e.g., digital content 704a) into a crypto collectible or digital asset on blockchain 604 (e.g., the Ethereum™ blockchain). The digital item or file (e.g., digital content 704a) can be stored in the blockchain 604 and cannot be able to be edited, modified, or deleted. The process of uploading a specific item onto the blockchain 604 is known as “minting.” For example, “NFT minting” can refer to a process by which a digital art or digital content 704a becomes a part of the Ethereum™ blockchain. Thus, the process turns digital content 704a into a crypto asset, which is easily traded or bought with cryptocurrencies on a digital marketplace without an intermediary.

FIG. 7B is a block diagram illustrating an example system 750 including a cryptographic wallet 760, in accordance with one or more embodiments of this disclosure. As a general overview, cryptographic wallet 760 is an electronic entity that allows users to securely manage digital assets. According to various embodiments, the cryptographic wallet 760 can be a hardware-based wallet (e.g., can include dedicated hardware component(s)), a software-based wallet, or a combination thereof. Example digital assets that can be stored and managed using the cryptographic wallet 760 include digital coins, digital tokens, and/or the like. In some embodiments, tokens are stored on a blockchain system, such as the blockchain system 600 described in FIG. 6. In some embodiments, the cryptographic wallet 760 may be capable of connecting to and managing assets that are native to or associated with multiple, different blockchain systems (e.g., including multiple blockchain systems having structure similar to or equivalent to blockchain system 600).

As defined herein, the terms “coin” and “token” refer to a digital representation of a particular asset, utility, ownership interest, and/or access right. Any suitable type of coin or token can be managed using various embodiments of the cryptographic wallet 760. In some embodiments, tokens include cryptocurrency, such as exchange tokens and/or stablecoins. Exchange tokens and/or stablecoins can be native to a particular blockchain system and, in some instances, can be backed by a value-stable asset, such as fiat currency, precious metal, oil, or another commodity. In some embodiments, tokens are utility tokens that provide access to a product or service rendered by an operator of the blockchain system 600 (e.g., a token issuer). In some embodiments, tokens are security tokens, which can be securitized cryptocurrencies that derive from a particular asset, such as bonds, stocks, real estate, and/or fiat currency, or a combination thereof, and can represent an ownership right in an asset or in a combination of assets.

In some embodiments, tokens are non-fungible tokens (NFTs) or other non-fungible digital certificates of ownership. In some embodiments, tokens are decentralized finance (DeFi) tokens. DeFi tokens can be used to access feature sets of DeFi software applications (dApps) built on the blockchain system 600. Example dApps can include decentralized lending applications (e.g., Aave), decentralized cryptocurrency exchanges (e.g., Uniswap), decentralized NFT marketplaces (e.g., OpenSea, Rarible), decentralized gaming platforms (e.g., Upland), decentralized social media platforms (e.g., Steemit), decentralized music streaming platforms (e.g., Audius), and/or the like. In some embodiments, tokens provide access rights to various computing systems and can include authorization keys, authentication keys, passwords, PINs, biometric information, access keys, and other similar information. The computing systems to which the tokens provide access can be both on-chain (e.g., implemented as dApps on a particular blockchain system) or off-chain (e.g., implemented as computer software on computing devices that are separate from the blockchain system 600).

As shown, the cryptographic wallet 760 of FIG. 7B is communicatively coupled to the host device 780 (e.g., a mobile phone, a laptop, a tablet, a desktop computer, a wearable device, and the like) via the communications link 755. In some embodiments, the host device 780 can extend the feature set available to the user of the cryptographic wallet 760 when it is coupled to the host device 780. For instance, the host device may provide the user with the ability to perform balance inquiries, convert tokens, access exchanges and/or marketplaces, perform transactions, access computing systems, and/or the like.

In some embodiments, the cryptographic wallet 760 and the host device 780 can be owned and/or operated by the same entity, user, or a group of users. For example, an individual owner of the cryptographic wallet 760 may also operate a personal computing device that acts as a host device 780 and provides enhanced user experience relative to the cryptographic wallet 760 (e.g., by providing a user interface that includes graphical features, immersive reality experience, virtual reality experience, or similar). In some embodiments, the cryptographic wallet 760 and the host device 780 can be owned and/or operated by different entities, users and/or groups of users.

The cryptographic wallet 760 and the host device 780 can be physically separate and/or capable of being removably coupled. The ability to physically and communicatively uncouple the cryptographic wallet 760 from the host device 780 and other devices enables the air-gapped cryptographic wallet (e.g., cryptographic wallet 760) to act as “cold” storage, where the stored digital assets are moved offline and become inaccessible to the host device 780 and other devices. Further, the ability to physically and communicatively uncouple the cryptographic wallet 760 from the host device 780 allows the cryptographic wallet 760 to be implemented as a larger block of physical memory, which extends the storage capacity of the cryptographic wallet 760, similar to a safety deposit box or vault at a brick-and-mortar facility.

Accordingly, in some embodiments, the cryptographic wallet 760 and the host device 780 are physically separate entities. In such embodiments, the communications link 755 can include a computer network. For instance, the cryptographic wallet 760 and the host device 780 can be paired wirelessly via a short-range communications protocol (e.g., Bluetooth, ZigBee, infrared communication) or via another suitable network infrastructure. In some embodiments, the cryptographic wallet 760 and the host device 780 are removably coupled. For instance, the host device 780 can include a physical port, outlet, opening, or similar to receive and communicatively couple to the cryptographic wallet 760, directly or via a connector.

In some embodiments, the cryptographic wallet 760 includes tangible storage media, such as a dynamic random-access memory (DRAM) stick, a memory card, a secure digital (SD) card, a flash drive, a solid state drive (SSD), a magnetic hard disk drive (HDD), or an optical disc, and/or the like and can connect to the host device via a suitable interface, such as a memory card reader, a USB port, a micro-USB port, an eSATA port, and/or the like.

In some embodiments, the cryptographic wallet 760 can include an integrated circuit, such as a SIM card, a smart cart, and/or the like. For instance, in some embodiments, the cryptographic wallet 760 can be a physical smart card that includes an integrated circuit, such as a chip that can store data. In some embodiments, the cryptographic wallet 760 is a contactless physical smart card. Advantageously, such embodiments enable data from the card to be read by a host device as a series of application protocol data units (APDUs) according to a conventional data transfer protocol between payment cards and readers (e.g., ISO/IEC 7816), which enhances interoperability between the cryptographic payment ecosystem and payment card terminals.

In some embodiments, the cryptographic wallet 760 and the host device 780 are non-removably coupled. For instance, various components of the cryptographic wallet 760 can be co-located with components of the host device 780 in the housing of the host device 780. In such embodiments, the host device 780 can be a mobile device, such as a phone, a wearable, or similar, and the cryptographic wallet 760 can be built into the host device. The integration between the cryptographic wallet 760 and the host device 780 can enable improved user experience and extend the feature set of the cryptographic wallet 760 while preserving computing resources (e.g., by sharing the computing resources, such as transceiver, processor, and/or display or the host device 780). The integration further enables the ease of asset transfer between parties. The integration can further enhance loss protection options, as recovering a password or similar authentication information, rather than recovering a physical device, can be sufficient to restore access to digital assets stored in the cryptographic wallet 760. In some embodiments, the non-removably coupled cryptographic wallet can be air-gapped by, for example, disconnecting the host device 780 from the Internet.

As shown, the cryptographic wallet 760 can include a microcontroller 762. The microcontroller 762 can include or be communicatively coupled to (e.g., via a bus or similar communication pathway) at least a secure memory 764. The cryptographic wallet 760 can further include a transceiver 782a, and input/output circuit 784a, and/or a processor 786a. In some embodiments, however, some or all of these components can be omitted.

In some embodiments, the cryptographic wallet 760 can include a transceiver 782a and therefore can be capable of independently connecting to a network and exchanging electronic messages with other computing devices. In some embodiments, the cryptographic wallet 760 does not include a transceiver 782a. The cryptographic wallet 760 can be capable of connecting to or accessible from a network, via the transceiver 782b of the host device 780, when the cryptographic wallet 760 is docked to the host device 780. For example, in some embodiments, the user of the cryptographic wallet 760 can participate in token exchange activities on decentralized exchanges when the cryptographic wallet 760 is connected to the host device 780.

In some embodiments, the cryptographic wallet 760 can include an input/output circuit 784a, which may include user-interactive controls, such as buttons, sliders, gesture-responsive controls, and/or the like. The user-interactive controls can allow a user of the cryptographic wallet 760 to interact with the cryptographic wallet 760 (e.g., perform balance inquiries, convert tokens, access exchanges and/or marketplaces, perform transactions, access computing systems, and/or the like). In some embodiments, the user can access an expanded feature set, via the input/output circuit 784b of the host device 780, when the cryptographic wallet 760 is docked to the host device 780. For example, host device 780 can include computer-executable code structured to securely access data from the secure memory 764 of the cryptographic wallet 760 and to perform operations using the data. The data can include authentication information, configuration information, asset keys, and/or token management instructions. The data can be used by an application that executes on or by the host device 780. The data can be used to construct application programming interface (API) calls to other applications that require or use the data provided by cryptographic wallet 760. Other applications can include any on-chain or off-chain computer applications, such as dApps (e.g., decentralized lending applications, decentralized cryptocurrency exchanges, decentralized NFT marketplaces, decentralized gaming platforms, decentralized social media platforms, decentralized music streaming platforms), third-party computing systems (e.g., institution computing systems, social networking sites, gaming systems, online marketplaces), and/or the like.

The secure memory 764 is shown to include an authentication circuit 766 and a digital asset management circuit 772. The authentication circuit 766 and/or digital asset management circuit 772 include computer-executable code that, when executed by one or more processors, such as one or more processors of processor 786a and/or processor 786b, performs specialized computer-executable operations. For example, the authentication circuit 766 can be structured to cause the cryptographic wallet 760 to establish, maintain and manage a secure electronic connection with another computing device, such as the host device 780. The digital asset management circuit 772 can be structured to cause the cryptographic wallet 760 to allow a user to manage the digital assets accessible via the cryptographic wallet 760. In some embodiments, the authentication circuit 766 and the digital asset management circuit 772 are combined in whole or in part.

As shown, the authentication circuit 766 can include retrievably stored security, authentication, and/or authorization data, such as the authentication key 768. The authentication key 768 can be a numerical, alphabetic, or alphanumeric value or combination of values. The authentication key 768 can serve as a security token that enables access to one or more computing systems, such as the host device 780. For instance, in some embodiments, when the cryptographic wallet 760 is paired or docked to (e.g., establishes an electronic connection with) the host device 780, the user may be prompted to enter authentication information via the input/output circuit(s) of input/output circuit 784a and/or input/output circuit 784b. The authentication information may include a PIN, a password, a pass phrase, biometric information (e.g., fingerprint, a set of facial features, a retinal scan), a voice command, and/or the like. The authentication circuit 766 can compare the user-entered information to the authentication key 768 and maintain the electronic connection if the items match at least in part.

As shown, the authentication circuit 766 can include retrievably stored configuration information such as configuration information 770. The configuration information 770 can include a numerical, alphabetic, or alphanumeric value or combination of values. These items can be used to enable enhanced authentication protocols. For instance, the configuration information 770 can include a timeout value for an authorized connection between the cryptographic wallet 760 and the host device 780. The configuration information 770 can also include computer-executable code. In some embodiments, for example, where a particular cryptographic wallet, such as cryptographic wallet 760, is set up to pair with only one or a small number of pre-authorized host devices such as host device 780, the configuration information 770 can include a device identifier and/or other device authentication information, and the computer-executable code may be structured to verify the device identifier and/or other device authentication information against the information associated with or provided by the host device 780. When a pairing is attempted, the computer-executable code may initiate or cause the host device 780 to initiate an electronic communication (e.g., an email message, a text message, etc.) using user contact information stored as configuration information 770.

As shown, the digital asset management circuit 772 can include retrievably stored digital asset data, such as the asset key 774. The asset key 774 can be a numerical, alphabetic, or alphanumeric value or combination of values. In some embodiments, the asset key 774 is a private key in a public/private key pair, a portion thereof, or an item from which the private key can be derived. Accordingly, the asset key 774 proves ownership of a particular digital asset stored on a blockchain system 600. The asset key 774 can allow a user to perform blockchain transactions involving the digital asset. The blockchain transactions can include computer-based operations to earn, lend, borrow, long/short, earn interest, save, buy insurance, invest in securities, invest in stocks, invest in funds, transmit and receive monetary value, trade value on decentralized exchanges, invest and buy assets, sell assets, and/or the like. The cryptographic wallet 760 can be identified as a party to a blockchain transaction on the blockchain system 600 using a unique cryptographically generated address (e.g., the public key in the public/private key pair).

As shown, the digital asset management circuit 772 can also include retrievably stored asset management instructions such as asset management instructions 776. The asset management instructions 776 can include a numerical, alphabetic, or alphanumeric value or combination of values. These items can be used to enable computer-based operations related to managing digital assets identified by the asset key 774. For instance, the asset management instructions 776 can include parameter values, metadata, and/or similar values associated with various tokens identified by the asset key 774 and/or by the blockchain system 600 associated with particular tokens. The asset management instructions 776 can also include computer-executable code. In some embodiments, for example, asset management functionality (e.g., balance inquiry and the like) can be executable directly from the cryptographic wallet 760 rather than or in addition to being executable from the host device 780.

### Remarks

The terms “example,” “embodiment,” and “implementation” are used interchangeably. For example, reference to “one example” or “an example” in the disclosure can be, but not necessarily are, references to the same implementation; and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described which can be exhibited by some examples and not by others. Similarly, various requirements are described which can be requirements for some examples but no other examples.

The terminology used herein should be interpreted in its broadest reasonable manner, even though it is being used in conjunction with certain specific examples of the disclosure. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the examples, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the above Detailed Description using the singular or plural number may also include the plural or singular number respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the disclosure, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel, or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the disclosure should not be taken to imply that the terminology is being redefined herein to be restricted to any specific characteristics, features, or aspects of the disclosure with which that terminology is associated. In general, the terms used in the following examples should not be construed to limit the disclosure to the specific examples disclosed herein, unless the above Detailed Description explicitly defines such terms. Accordingly, the actual scope of the disclosure encompasses not only the disclosed examples, but also all equivalent ways of practicing or implementing the disclosure under the examples. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the disclosure can be modified to employ the systems, functions, and concepts of the various references described above to provide yet further implementations of the disclosure.

To reduce the number of claims, certain implementations are presented below in certain forms, but the applicant contemplates various aspects of the disclosure in other forms. For example, aspects of a claim can be recited in a means-plus-function form or in other forms, such as being embodied in a computer-readable medium. A claim intended to be interpreted as a mean-plus-function claim will use the words “means for.” However, the use of the term “for” in any other context is not intended to invoke a similar interpretation. The applicant reserves the right to pursue such additional claim forms in either this application or in a continuing application.

I/we claim:

1. A computer system for cryptographic security, the computer system comprising:
at least one hardware processor; and
at least one non-transitory memory storing instructions, which, when executed by the at least one hardware processor, cause the computer system to:
receive, from a computer device associated with a cryptographic wallet, a verification request including identification information identifying an entity associated with the cryptographic wallet;
in response to receiving the verification request,
generate, using an identity verification standard and based on the identification information, an identity verification token verifying the entity associated with the cryptographic wallet, and
transmit the identity verification token to the computer device;
receive, from a transaction server, a validation request associated with a cryptographic transaction and including the identity verification token,
wherein the cryptographic transaction is linked to the cryptographic wallet; and
in response to receiving the validation request,
validate, using the identity verification standard, the identity verification token to generate validation information for the entity associated with the cryptographic wallet; and
transmit the validation information to the transaction server for performing the cryptographic transaction linked to the cryptographic wallet.

2. The computer system of claim 1, wherein the cryptographic transaction is stored in a block of a block chain, and
wherein the block includes the identity verification token, an identifier of the cryptographic wallet, an amount of cryptocurrency processed by the cryptographic transaction, and/or a date and time of the cryptographic transaction.

3. The computer system of claim 2, wherein the block includes an address of the wallet, a username of the wallet, a screenname of the wallet, a barcode of the wallet, and/or a quick response (QR) code of the wallet.

4. The computer system of claim 1, wherein the identity verification standard is a Know Your Customer (KYC) or an eKYC standard.

5. The computer system of claim 1, wherein the transaction server is part of the computer system.

6. The computer system of claim 1, wherein the cryptographic wallet is a software wallet or a hardware wallet.

7. The computer system of claim 1, wherein the identity verification token is a onetime password, a disconnected token, a connected token, a contactless token, a single sign-on software token, or a programmable token.

8. At least one non-transitory computer-readable storage medium storing instructions, which, when executed by at least one data processor of a first computer system, cause the first computer system to:
transmit, to a second computer system, a verification request including first identification information identifying a first entity associated with a first digital wallet, and second identification information identifying a second entity associated with a second digital wallet,
wherein the verification request is associated with a digital transaction between the first entity and the second entity;
receive, from the second computer system, an identity verification token verifying the first entity and the second entity,
wherein the identity verification token is generated using an identity verification standard and is based on the first identification information and the second identification information; and
in response to receiving the identity verification token,
link the digital transaction to the first digital wallet and the second digital wallet using the identity verification token; and
perform the digital transaction by transferring an amount of virtual currency between the first digital wallet and the second digital wallet.

9. The non-transitory computer-readable storage medium of claim 8, wherein the identity verification token is valid for a period of time.

10. The non-transitory computer-readable storage medium of claim 8, wherein the identity verification token is valid for a number of digital transactions.

11. The non-transitory computer-readable storage medium of claim 8, wherein the digital transaction is linked to the first digital wallet and the second digital wallet by a cryptographic key.

12. The non-transitory computer-readable storage medium of claim 8, wherein the identity verification token is generated using identifiers of the first digital wallet and the second digital wallet, the amount of virtual currency, and/or a date and time of the digital transaction.

13. The non-transitory computer-readable storage medium of claim 8, wherein the digital wallet includes a desktop program, a browser extension, and/or a mobile application.

14. The non-transitory computer-readable storage medium of claim 8, wherein the instructions cause the first computer system to:
receive, from a computer device associated with the first entity, a transaction request to perform a second digital transaction,
wherein the transaction request includes a second identity verification token associated with the first entity.

15. A method performed by a computer system, the method comprising:
receiving, from a computer device associated with a digital wallet, a verification request including identification information identifying an entity associated with the digital wallet;
generating, using an identity verification standard and based on the identification information, an identity verification token verifying the entity;
transmitting the identity verification token to the computer device;
receiving, from the computer device, a transaction request for performing a digital transaction linked to the digital wallet,
wherein the transaction request includes the identity verification token;
validating, using the identity verification standard, the identity verification token; and
performing the digital transaction linked to the digital wallet.

16. The method of claim 15, wherein the digital wallet is an electronic device configured to store digital currency offline.

17. The method of claim 15, wherein the digital wallet includes a web-based interface and/or a community software application.

18. The method of claim 15, wherein the identity verification token is generated using biometric data of the entity, a digital upload of documentation, multi-factor authentication, digital breadcrumbs of the entity, a one-time password (OTP), and/or a trusted data source.

19. The method of claim 15, wherein the transaction request comprises a non-fungible token.

20. The method of claim 15, wherein the transaction request includes a second identity verification token associated with a second digital wallet, and
wherein the digital transaction is performed between the wallet and the second digital wallet.
